(19) United States
(12) Patent Application Publication
(10) Pub. No.: US 2005/0286793 A1
(43) Pub. Date: Dec. 29, 2005

(54) Photographic image processing method and equipment

(76) Inventors: Keisuke Izumi, Osaka City (JP); Hiroyuki Okamoto, Wakayama City (JP)

Correspondence Address: SMITH PATENT OFFICE, 1901 PENNSYLVANIA AVENUE N W, SUITE 901, WASHINGTON, DC, 20006, US

(21) Appl. No.: 11/157,903

(22) Filed: Jun. 22, 2005

(30) Foreign Application Priority Data
Jun. 24, 2004 (JP) 2004-185953

(51) Int. Cl. G06K 9/40; G06K 9/46

(52) U.S. Cl. 382/263; 382/190

(57) ABSTRACT

The present invention comprises a face area detection means for detecting a face area of a person from original image data, a skin information extraction means for extracting skin information equivalent to the detected face area, a first image processing means for performing a sharpening operation or a granulation control operation on the detected skin area, and a second image processing means for performing a sharpening operation or a granulation control operation on at least data of areas other than the skin area, which is different in intensity from the sharpening operation or the granulation control operation by the first image processing means. The present invention separates the skin area from the other areas of a photographic subject and subjects these areas to respective appropriate sharpening operations at high speeds.

### BACKGROUND OF THE INVENTION

1. Field of the Invention

The present invention relates to a photographic image processing method, a photographic image processing equipment, and a photographic image processing computer program product by which a sharpening operation is performed on data of an original image read by a film scanner from a developed silver salt photographic film and data of an original image photographed by a digital still camera.

2. Description of the Related Art

Generally, in processing a silver salt photographic image captured by a film scanner as a digital image and producing its printed output on a photographic printer, there occurs a problem in which an output photograph suffers a degradation in picture quality with a lowered degree of sharpness owing to factors inherent in input devices such as a film scanner and digital still camera and output devices including a photographic printer.

In particular, a Laplacian filter or Unsharp Mask filter are used to perform a sharpening operation in order to improve the sharpness that has become low through image scaling, etc. However, such a sharpening operation causes a problem in which, as the sharpness of an image improves, granular noises become noticeable all the more on flat areas such as a face and other skin parts, which makes the image look rough.

Lowering the level of a sharpening operation would reduce the roughness of an image but would not make it possible to obtain a photographic print worth seeing because the degree of sharpness becomes low in the entire image. Such a problem is not specific to a silver salt photograph, and is also recognized in a digital image photographed by a digital still camera, etc., where, as the sharpness of an image is raised, various noises such as shot noises and electrical noises contained in a video signal at the time of photographing become more conspicuous.

Thus, there have been conventionally proposed a variety of image processing methods by which the characteristics of an original image are extracted and intricately intertwined sharpening operations are carried out according to the extracted original image characteristics.

For instance, Japanese Unexamined Patent Publication No. H11-266358 (1999) aims to provide an image processing method by which a photographic subject having a specific color, for example, a specific area occupied by an important color such as a skin color of a person is extracted from a color original image and subjected to image processing including dynamic range compression and decompression such as dodging, without emphasizing granular noises or causing any false outline in the specific area of skin color. Proposed in this patent document is an image processing method by which, in obtaining image data for reproducing digital original image data indicative of a color original image as a visible image, this original image data is subjected to a filtering operation by an edge-retained smoothing filter to generate out-of-focus image data indicative an out-of-focus image of the original image, a skin color area of the original image is extracted from skin color pixels extracted from this out-of-focus image data, and an appropriate image processing operation is performed on this area.

However, the above described related art causes a problem where complex operations need to be repeatedly done on the entire image even though image roughness constitutes an important issue in only a face area of a person, etc., which makes processing time longer.

In addition, skin colors of persons as photographic subjects are generally different in individuals. The related art set forth in the above mentioned patent document poses a problem that, in extracting a skin-color area of a photographic subject, a threshold of skin color as an extraction criterion cannot be fixed and a widened range of pixels to be extracted may result in incorrect detection of parts other than the skin. Consequently, this related art leaves further room for improvement in carrying out a process of raising the degree of sharpness at a high speed while suppressing image roughness caused by granular noises in a skin area of a person as an important photographic subject.

### SUMMARY OF THE INVENTION

In view of the above stated conventional problems, it is an objective of the present invention to provide a photographic image processing method and equipment or the like which make it possible to separate a skin area from the other areas of a photographic subject and perform high-speed image processing for subjecting these areas to respective appropriate sharpening operations.

A photographic processing method of the present invention to attain this objective is a photographic image processing method of performing a sharpening operation on input original image data, comprising a face area detection step of detecting a face area of a person from the original image data, a skin information extraction step of extracting skin information equivalent to the detected face image, a skin area detection step of detecting a skin area based on the extracted skin information, and a first image processing step of performing a sharpening operation or a granulation control operation on the detected skin area.

Preferably, the above described method further comprises a second image processing step of performing a sharpening operation or a granulation control operation on at least data of areas other than the skin area, which are different in intensity from the sharpening operation and granulation control operation in the first image processing step.

More preferably, the first image processing step is of cutting out the skin area data from the original image data and performing a sharpening operation or a granulation control operation on the cut skin area data, and the second image processing step is for performing a sharpening operation or a granulation control operation on the original image data, which is different in intensity from the sharpening operation or the granulation control operation in the first image processing step, and pasting the skin area data processed in the first image processing step to the above processed image data.

Furthermore, the other inventions are explicitly presented with reference to the embodiments below.

### BRIEF DESCRIPTION OF THE DRAWINGS

FIG. 1 is an outline view of a photographic processing equipment of the present invention;

FIG. 2 is a block diagram of an image data processing part of the present invention;

FIG. 3 is a functional block diagram of a system controller and image processing part;

FIG. 4 is a flowchart showing a sharpening operation procedure of the present invention;

FIG. 5A is an explanatory diagram showing a sharpening operation procedure of the present invention, where a face area is detected from an original image;

FIG. 5B is also an explanatory diagram showing the sharpening operation procedure of the present invention, where skin areas detected on the basis of color information, etc. of the face area are extracted;

FIG. 5C is also an explanatory diagram showing the sharpening operation of the present invention, where the image of the skin area subjected to the first sharpening operation is pasted to the image sharpened by the second image processing means;

FIG. 6 is an explanatory diagram of a skin information extraction process using a hue/saturation table; and

FIGS. 7A to 7E are explanatory diagrams of a Laplacian filter operation, in which FIG. 7A is an explanatory diagram of an original image,

FIG. 7B is an explanatory diagram of a primary differential image, FIG. 7C is an explanatory diagram of a secondary differential image, FIG. 7D is an explanatory diagram of an image where a secondary differential value is subtracted from the original image, and FIG. 7E is an explanatory diagram of a Laplacian filter.

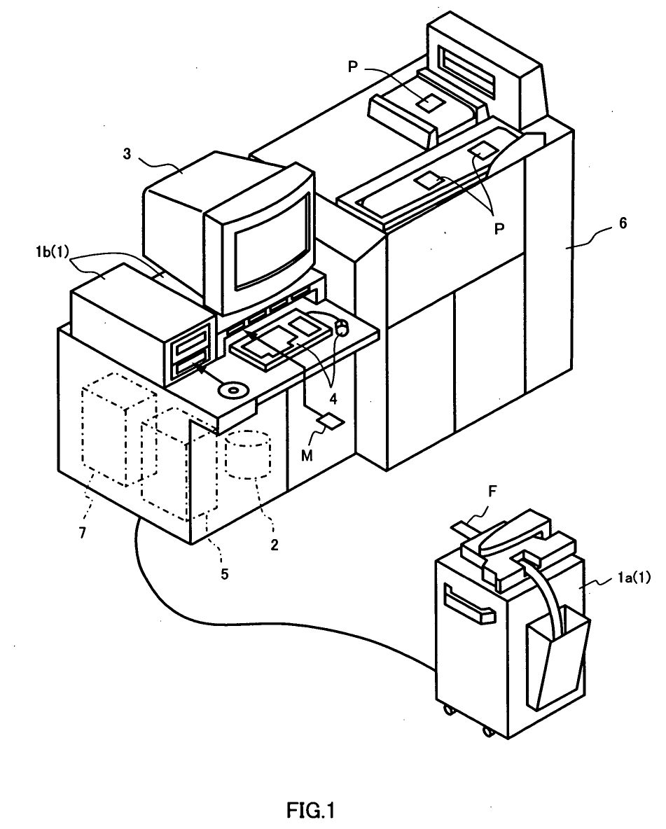

### DESCRIPTION OF THE PREFERRED EMBODIMENTS

Based on the drawings, descriptions are given below as to a photographic image processing method of the present invention, a photographic processing equipment and a photographic image processing computer program product using the processing method.

The digital photographic image processing equipment comprises: an image data input part 1 comprising a film scanner 1a for reading a photographic image from a photographed negative film (hereinafter just referred to as “film”) F or the like and a media driver 1b for supporting various kinds of card-type memory M such as an SD card and a memory stick storing data of an image photographed by a digital still camera; an image data storage part 2 composed of a hard disk or the like storing input image data; a monitor 3 for displaying an image based on the image data; an operation input part 4 equipped with a keyboard and a mouse; an image processing part 5 for editing the image data based on various operations through the operation input part 4 with respect to the image displayed on the monitor; a photographic printer 6 for exposing a photographic paper sheet P to light and generating a photographic print based on the data subjected to image processing; and a system controller 7 for controlling the above mentioned blocks as a system (hereinafter referred to as “controller 7”).

The film scanner 1a comprises an illumination optical system 10 for irradiating the film F with illumination light, a film transport part 11 for transporting the film F, an image reading part 12 for reading a frame image recorded on the film F transported by the film transport part 11, and a scanner control part 13 for controlling an image reading process by the illumination optical system 10, the film transport part 11 and the image reading part 12.

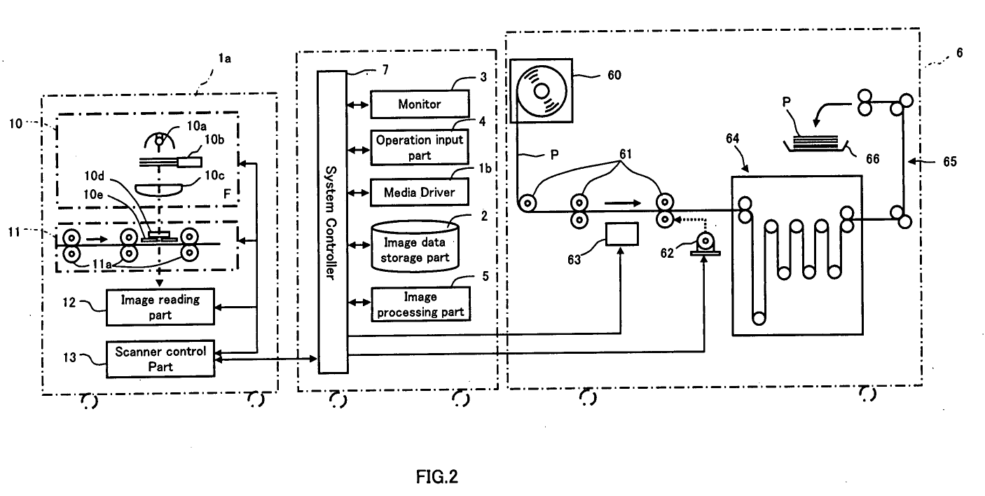

The illumination optical system 10 comprises a bar halogen lamp 10a arranged in the direction of primary scan orthogonal to the direction of secondary scan (indicated by an arrow in FIG. 2) in which the film F is transported, a dimmer filter 10b for adjusting a color distribution in a bundle of rays from the halogen lamp 10a, a cylindrical lens 10c for concentrating the bundle of rays in the form of a slit, a diffuser panel 10d for evening out an intensity distribution, and a narrow slit 10e.

The film transport part 11 is driven by a transport motor outside the drawing, and comprises a plurality of transport roller pairs 11a for transporting the continuous film F toward a film projection part immediately below the slit 10e at a predetermined speed.

The image reading part 12 includes a condensing lens, a CCD line sensor, a sample hold circuit, an A/D converter, etc., and is configured in such a manner that a slit light from the illumination optical system 10, which has been transmitted through the film F, is imaged on the CCD line sensor by a condenser lens and that an analog signal read by the CCD line sensor is converted into digital data by the A/D converter. The CCD line sensor is composed of three line sensors each of which is provided with a color filter for selectively letting pass an R component, G component and B component of the film-transmitted light. Thus, with the transport of the film F, each of frame images on the film is read in a state of being decomposed into R, G and B color components.

The photographic printer 6 includes a paper magazine 60 for storing a roll photographic paper 60, a plurality of photographic paper feed rollers 61 for drawing out and feeding the photographic paper P from the paper magazine 60, a motor 62 for driving the feed rollers 61, a fluorescent-beam print head 63 for exposing to light the photosensitive side of the fed photographic paper, a development part 64 for subjecting the light-exposed photographic paper P to development, bleaching and fixing operations, a dryer part 65 for transporting the developed photographic paper P while drying the same, and a discharge part 66 for discharging the dried photographic paper P as a final print. The photographic paper P drawn out from the paper magazine 60 is cut to a predetermined print size by a cutter (not shown) arranged before or after the development operation, and output to the discharge part 66.

The print head 63 is composed of three rows of red-color light-emitting block, green-color light-emitting block and blue-color light-emitting block where phosphor devices are aligned in the direction of primary scan, the phosphor device being formed by attaching a lens and a color filter to a phosphor of which light emission is controlled by adjustment of a grid voltage. By driving and controlling it based on each pixel data of R component, G component and B component of image data read by the film scanner 1a, etc. and then edited, a photographic image is light-exposed on the printing paper P.

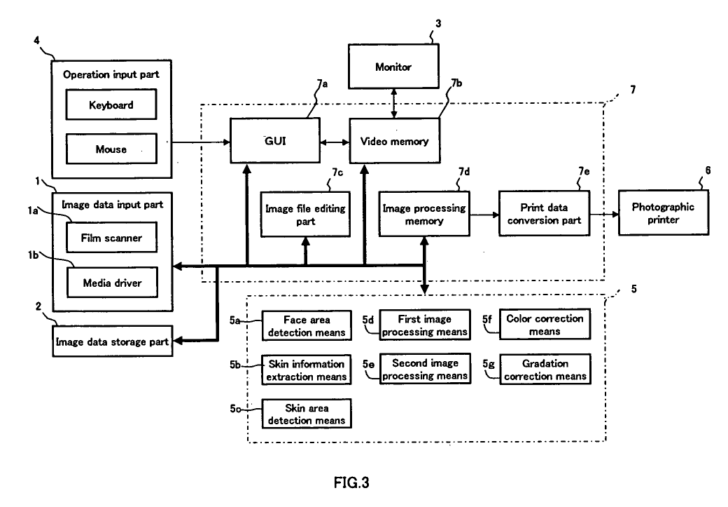

The controller 7 includes a CPU, ROM, RAM used as a data processing area, RAM used for image data editing, hardware equipped with peripheral circuitry, and software composed of programs stored in the ROM and executed by the CPU. When divided into functional blocks related to the present invention, as shown in FIG. 3, it includes: a graphic user interface part 7a (hereinafter referred to as “GUI part”) for displaying a graphic operation screen containing software switches in a window displayed on the monitor 3 and generating a control command corresponding to a user operation from the operation input part 4 via the graphic operation screen; a video memory 7b for storing data to be displayed on the monitor 3; an image processing memory 7d for loading an image read from the image data storage part 2 and subjecting the image to various kinds of image processing; an image file editing part 7c for editing the processed image data as an image file to be written into a medium such as a CD-R; a print data conversion part 7e for converting the data subjected to image processing into output data conforming to the photographic printer 6e; and the like.

The image processing part 5 includes: a face area detection means 5a composed of software for editing a target image by a predetermined algorithm and hardware equipped with an image processing processor, and for detecting a person face area from image data loaded into the image processing memory 7d; a skin information extraction means 5b for extracting skin information equivalent to the face area detected by the face area detection means 5a; a skin area detection means 5c for detecting a skin area from the original image based on the skin information extracted by the skin information extraction means 5b; a first image processing means 5d for performing a sharpening operation or a granulation control operation on the skin area detected by the skin area detection means 5c; a second image processing means 5e for performing a sharpening operation or a granulation control operation on at least data of areas other than the skin area, which is different in intensity from the sharpening operation or the granulation control operation by the first image processing means 5d; a color correction means 5f for adjusting a color balance; a gradation correction means 5g for adjusting a gradation; and the like.

When an instruction for film reading is transmitted from the controller 7, the scanner control part 13 turns on the halogen lamp 10a and then drives the film transport part 11 to transport the film F at a predetermined speed in the direction of secondary scan. The image reading part 12 reads frame images in sequence recorded on the film, and transmits the read image data to the controller 7. The image data transmitted from the scanner control part 13 is stored in the image data storage part 2.

Additionally, when a medium is inserted into the media driver 1b under control of the controller 7, image data stored in the medium is read and stored in the image data storage part 2.

The image data stored in the image data storage part 2 is subjected by the image processing part 5 to predetermined image processing, and print data converted by the print data conversion part 7e is output to the photographic printer 6. In the photographic printer 6, the print head 63 is driven on the basis of the input print data, and the photographic paper P exposed to light by the print head 63 is developed and output as a photographic print.

More specifically, in generating a photographic print on the photographic image processing equipment based on an image input from the film scanner 1a, the film image is firstly read at low definition by a pre-scan and displayed on the monitor 3. For the displayed frame images, print sizes and print volumes are set by an operator via the operation input part 4, and also image quality of each frame image including a color balance is verified.

This verification is carried out in the form of interaction between the controller 7 and the operator. In a series of operations for determining conditions for image processing by the image processing part 5 in addition to the above described print volume setting, a sequence of image processing operations such as sharpening, color correction and gradation correction is automatically executed under predetermined conditions and a low-definition image is displayed on the monitor 3. The operator evaluates whether the results of corrections made to the image are adequate or not. If there are some problems such as occurrence of a color failure, color correction or the like is manually performed and the conditions for the correction are stored in the internal memory.

When the above verification is completed and a photographic print is output, a full-scale scan, that is, reading of a film image is done at high resolution by the film scanner 1a, and the above mentioned various kinds of image processing are performed on the full-scale scanned image data. As required, image processing is carried out under the correction conditions defined during the verification. After that, print data converted by the print data conversion part 7e is output to the photographic printer 6.

Pre-scan is provided for the purpose of speeding up of the image processing carried out during the above described verification by decreasing the number of target pixels. As for an image photographed by a digital still camera, the verification is performed on a thumbnail image included in the read image file. If there is no thumbnail image, the verification is carried out on a thumbnail image generated by thinning out the input image.

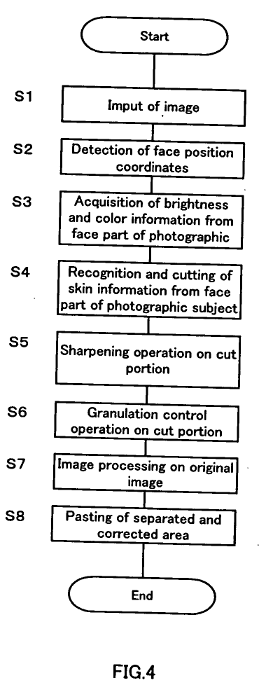

According to the flowchart shown in FIG. 4, a description is given below as to an image editing step of high-resolution image data obtained from a full-scale scan by the film scanner 1a or high-resolution image data input from the media driver 1b.

The image data input from the image data input part 1 and stored in the image data storage part 2 is expanded by frame images in the image processing memory 7d in RGB dot sequential RAW mode or RGB frame sequential RAW mode (S1), and a face area is detected by the face area detection means 5a (S2).

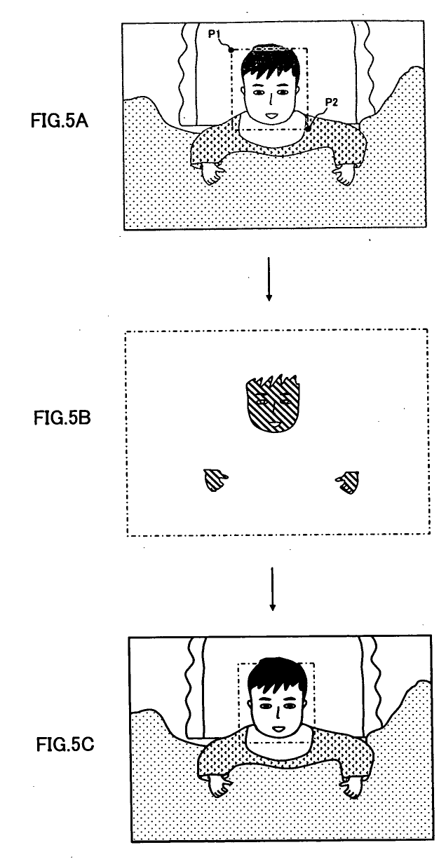

A variety of known algorithms can be used for the detection of a face area by the face area detection means 5a. Based on such an algorithm, a pair of diagonal coordinates P1 and P2 is output as a smallest rectangular area containing the face area from the original image data, as shown in FIG. 5A. The detection of the face area here may be done by the face area detection means 5a with respect to the pre-scanned low-resolution data or thumbnail image data during the verification, and diagonal coordinates in the high-resolution data may be determined by an arithmetic operation based on the obtained diagonal coordinates P1 and P2.

As an algorithm for face area detection, a pattern matching method can be used, for example. According to this method, a single or a plurality of combined form patterns for face line, eyes, nose, mouth, ears, etc. in a face area are registered in advance, and a person's face area is detected depending on whether or not there exists a pattern in an image that matches any of the registered patterns. The sizes, forms and layouts of face line, eyes and nose are different from person to person, and also the form patterns can vary even in one and the same person according to his expressions. In this regard, this method makes it possible to evaluate the degree of match with a registered form pattern by using a neural network or a genetic algorithm, thereby improving the accuracy of matching. Accordingly, output is the smallest rectangular area containing the detected face area, that is, the pair of diagonal coordinates P1 and P2 containing at least the face line. Besides, it is also possible to adopt a method of specifying with a mouse a face area from an image displayed on the monitor 3.

Next, the skin information extraction means 5b samples pixels of skin area excluding the eyes and mouth within the face line from the detected face area, extracts RGB color information and derives brightness information as an average value among the pixels by an arithmetic operation (S3).

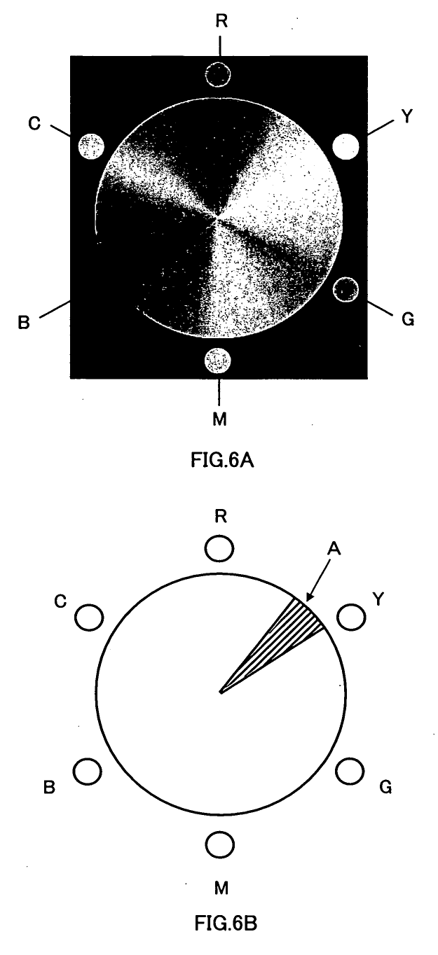

The skin area detection means 5c determines a fan-shaped area A shown in FIG. 6B containing the upper and lower limits of a range in which the color information extracted by the skin information extraction means 5b distributes over the hue/saturation table (HueSat table) presented in FIG. 6A, recognizes color information contained in the area A as color information indicative of a skin color, detects pixels as a skin area from the original image, which have the same color information as the color information contained in the area A and have the brightness equivalent to the brightness information determined by the skin information extraction means 5b, and cuts out the skin area (S4). The skin area detected from the original image in this manner is indicated by hatching in FIG. 5B.

The first image processing means 5d sharpens the skin area detected by the skin area detection means 5c by applying a Laplacian filter at a predetermined standard intensity (S5), and controls granular noises that have become noticeable due to the sharpening operation (S6). The granulation control operation is a smoothing filter operation for controlling granular noises contained in an input image from a silver salt film, and shot noises, electrical noises, etc. that occur on an image photographed by a digital still camera. In particular, this operation is implemented by applying to each of RGB a median filter or a variable weighted average filter for selectively smoothing out minute variations while saving major density changes.

According to the above described structure, skin information is extracted in the skin information extraction step on the basis of the face area detected from the original image in the face area detection step. This makes it possible to positively extract skin information of a person whatever his skin color may be, and reliably detect a skin area contained in the original image based on the extracted skin information in the skin area detection step. Also, in the first image processing process, an appropriate sharpening operation or granulation control operation is performed on the detected skin area, which makes it possible to obtain an image of a person as a main photographic subject with a high degree of sharpness in the face or skin area while sufficiently suppressing roughness in the skin area.

Then, the second image processing means 5e performs a sharpening operation on the original image by using a Laplacian filter of a higher intensity than the Laplacian filter used by the first image processing means 5d (S7) to raise the sharpness of the areas other than the skin area, and, as required, performs a granulation control operation on the original image at an intensity different from the intensity of the smoothing filter used by the first image processing means 5d (S7). After that, the second image processing means 5e pastes the image of the skin area processed by the first image processing means 5d to the image processed by the second image processing means 5e as shown in FIG. 5C, which completes the sharpening operation (S8).

In the above mentioned second image processing process, a sharpening operation or a granulation control operation different in intensity from the sharpening operation or the granular control operation in the first image processing step is carried out on the areas other than the skin area. With this, it is possible to obtain an image with a high degree of sharpness while sufficiently suppressing roughness in the areas other than the skin area, which result in a high-quality photographic image as a whole.

In the above mentioned steps S7 and S8, the second image processing means 5e may cut out a plurality of areas that surround the skin areas cut out from the original image and are radially wider than the skin areas, perform a sharpening operation on each of the areas at a higher intensity with distant from the skin area, and paste each of image data after the sharpening operation in order in which they are distant from the skin area.

In this case, the degree of sharpness changes in such a manner as to become gradually higher in a radial pattern from the skin area, and thus even if a sharpening operation is performed on the skin area at a significantly lowered degree of intensity, it is possible to sharpen the skin area and its peripheries in a natural manner without causing such a problem where a boundary of sharpness is sensed between the adjacent areas.

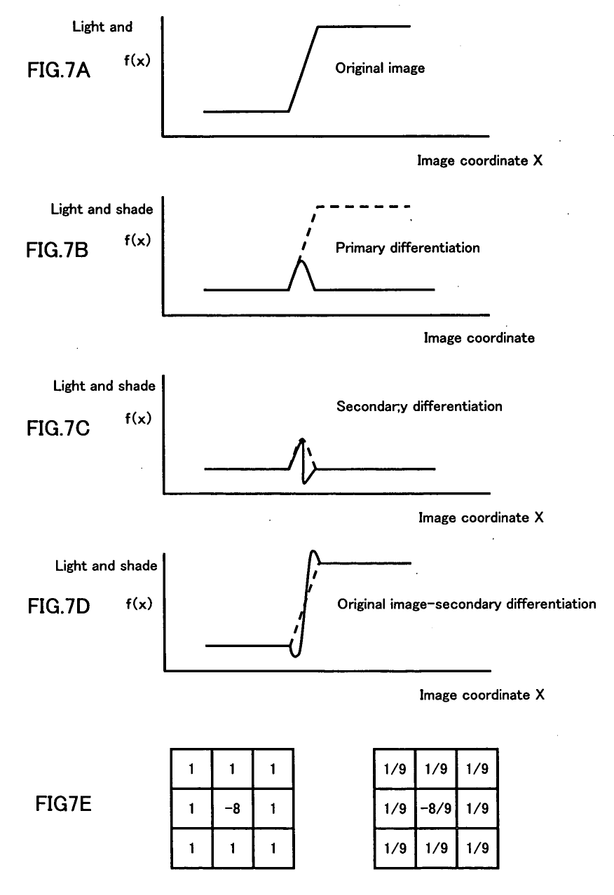

A more detailed description is given below as to the above mentioned Laplacian filtering. As shown in FIGS. 7A to 7D, the original image data is subjected to a secondary differentiation process, and a series of arithmetic operations is executed for each of RGB components to subtract the resulting value from the original image data. This generates undershoot portions and overshoot portions that do not exist in the original image and also increases the degrees of skewing of edges, which allows an image to be clearly displayed with an emphasized contrast in the edges. The size of a filter is appropriately set according to the size of the original image. For example, a filter size of 3×3 is suitable for 3000×2000 pixels, and a filter size of 5×5 is preferable to 6000×4000 pixels.

However, such a sharpening operation also enhances the edges of granular noises contained in image data input from a silver salt photographic film and shot noises and electrical noises contained in image data from a digital still camera, even in an area with a less noticeable contrast such as a skin area of a face, thereby causing roughness in the image.

On this account, the present invention adjusts the intensity of a sharpening operation at least in a skin area where roughness is noticeable and the other areas. The intensity of a Laplacian filter used for image sharpening can be adjusted with use of such a filter as shown in the right side of FIG. 7E obtained by multiplying a Laplacian filter as shown in the left side of FIG. 7E by a weighting factor of a smoothing filter such as a moving average filter, for example. The intensity of a sharpening operation with a Laplacian filter can be adjusted by multiplying each component of the filter by a weighting factor as stated above, and thus can be increased by raising the factor corresponding to a central pixel or enlarging the filter size and can be regulated by combining these conditions.

Additionally, in the above mentioned granulation control operation, a median filter or a variable weighted average filter is applied to each color of RGB. As in the case with the sharpening operation discussed above, the intensity of a granulation control operation can be also realized by changing the filter size or adjusting the filter factor.

Moreover, the above mentioned first image processing means 5d and second image processing means 5e perform both a sharpening operation and a granulation control operation. Alternatively, these means may perform either one of the two operations.

The image data subjected to a sharpening operation or a granulation control operation by the first and second image processing means 5d and 5e is then corrected in color by the color correction means 5f. In the color correction operation, for example, based on Evance's theory that mixing all colors in a negative for an average outdoor photographic subject would produce a nearly gray color, if colors of an image are unbalanced, light exposure of each of RGB is adjusted in such a manner that accumulated light of RGB passing through a negative film is reproduced as a gray color on the photographic paper. This operation is performed by calculating an average value of input image data for each of RGB of each pixel and adjusting the average value for each of RGB in such a manner as to become a predetermined value corresponding to a gray color. An image of which color correction conditions are separately set at the time of the above described verification is corrected on the basis of these correction conditions.

Furthermore, in order for an output photographic print to be reproduced with a predetermined gradation, the gradation correction means 5g converts the color-corrected image data according to correction table data obtained from a test print based on the kind of the photographic paper P and the state of developer of the photographic printer 6, and the print data conversion part 7e converts the processed data into print data and outputs it.

A program product for executing the above described sharpening operation is stored in a ROM provided in the image processing part 5 and executed by the image processing processor. This photographic image processing program product carries out: a face area detection step of detecting a face area of a person from an input original image data; a skin information extraction step of extracting skin information equivalent to the detected face area; a skin area detection step of detecting a skin area based on the extracted skin information; a first image processing step of performing a sharpening operation or a granulation control operation on the detected skin area; and a second image processing step of performing a sharpening operation or a granulation control operation on at least data of areas other than the skin area, which is different in intensity from the sharpening operation or granulation control operation in the first image processing process.

In the first image processing process, the skin area data is cut out from the original image data, and a sharpening operation or a granulation control operation is performed on the cut skin area data. In the second image processing process, a sharpening operation or a granulation control operation different in intensity from the sharpening operation or the granulation control operation in the first image processing step is performed on the original image data, and the skin area data processed in the first image processing step is pasted to the processed original image data.

In addition, adopted as the skin information is color information or brightness information indicative of a skin color extracted from the detected face area.

A description is provided below as to another embodiment of the present invention. In the above discussed embodiment, a photographic image processing method, a photographic image processing equipment and a photographic image processing program product for sharpening original image data, comprising: a face area detection step of detecting a face area of a person from an input original image data; a skin information extraction step of extracting skin information equivalent to the detected face area; a skin area detection step of detecting a skin area based on the extracted skin information; a first image processing step of performing a sharpening operation or a granulation control operation on the detected skin area; and a second image processing step of performing a sharpening operation or a granulation control operation on at least data of areas other than the skin area, which is different in intensity from the sharpening operation or granulation control operation in the first image processing process. Another embodiment may be a photographic image processing method, photographic image processing equipment and photographic image processing program product from which the second image processing step or the second image processing means are skipped so as to carry out up to the first image processing process.

In this case, a sharpening operation or a granulation control operation is performed on at least a face or skin area of a person as a main photographic subject to improve in quality an image of the person, thereby obtaining a presentable photographic print.

The face detection algorithms in the above described embodiment are just examples, and not limited to them, other known face detection algorithms can be used as well.

The sharpening operation described in the above embodiment uses a Laplacian filter. The size and coefficient of a used Laplacian filter are to be appropriately set and not limited to the examples presented herein.

The above described skin area detection means 5c detects a skin area based on RGB color information and brightness information of pixels indicative of skin detected by the information detection means. The detection of a skin area may be at least based on the RGB color information alone. Needless to say, the addition of brightness information would improve the accuracy of detection.

The above described specific structure of the image processing part 5 is not only configured as to perform software operations by use of the high-speed image processing processor but also may be configured with hardware using ASIC or the like. Additionally, in performing software operations, this part can be implemented in a form of being installed in the hard disk of the equipment, as an application program to be executed under control of an Os.

In the above described embodiment, the photographic image processing program is installed in the photographic image processing equipment comprising a film scanner and a photographic printer. Alternatively, this program may be installed in a personal computer which is implemented as an image editing apparatus.

As described above, the present invention makes it possible to provide a photographic image processing method and equipment which can separate a skin area of a photographic subject from the other areas and subject these areas to respective appropriate sharpening operations at high speeds.

This application is based on Japanese Patent Application No. 2004-185953 filed on Jun. 24, 2004, the contents of which are incorporated herein by reference.

1. A photographic image processing method of performing a sharpening operation on input original image data, comprising:
a face area detection step of detecting a face area of a person from the original image data;
a skin information extraction step of extracting skin information equivalent to the detected face image;
a skin area detection step of detecting a skin area based on the extracted skin information; and
a first image processing step of performing a sharpening operation or a granulation control operation on the detected skin area.

2. A photographic image processing method of performing a sharpening operation on input original image data, comprising:
a face area detection step of detecting a face area of a person from the original image data;
a skin information extraction step of extracting skin information equivalent to the detected face image;
a skin area detection step of detecting a skin area based on the extracted skin information;
a first image processing step of performing a sharpening operation or a granulation control operation on the detected skin area; and
a second image processing step of performing a sharpening operation or a granulation control operation on at least data of areas other than the skin area, which are different in intensity from the sharpening operation and granulation control operation in the first image processing step.

3. A photographic image processing method as set forth in claim 2, wherein
in the first image processing step, the skin area data is cut out from the original image data and a sharpening operation or a granulation control operation is performed on the cut skin area data; and
in the second image processing step, a sharpening operation or a granulation control operation is performed on the original image data, which is different in intensity from the sharpening operation or the granulation control operation in the first image processing step, and the skin area data processed in the first image processing step is pasted to the above processed image data.

4. A photographic image processing method as set forth in claim 1, wherein
the skin information is color information or brightness information indicative of a skin color extracted from the detected face area.

5. A photographic image processing equipment for performing a sharpening operation on input original image data, comprising:
a face area detection means for detecting a face area of a person from the original image data;
a skin information extraction means for extracting skin information equivalent to the detected face image;
a skin area detection means for detecting a skin area based on the extracted skin information; and
a first image processing means for performing a sharpening operation or a granulation control operation on the detected skin area.

6. A photographic image processing equipment for performing a sharpening operation on input original image data, comprising:
a face area detection means for detecting a face area of a person from the original image data;
a skin information extraction means for extracting skin information equivalent to the detected face image;
a skin area detection means for detecting a skin area based on the extracted skin information;
a first image processing means for performing a sharpening operation or a granulation control operation on the detected skin area; and
a second image processing means for performing a sharpening operation or a granulation control operation on at least data of areas other than the skin area, which are different in intensity from the sharpening operation and granulation control operation by the first image processing means.

7. A photographic image processing equipment as set forth in claim 6, wherein
the first image processing means cuts out the skin area data out from the original image data and performs a sharpening operation or a granulation control operation on the cut skin area data; and
the second image processing means performs a sharpening operation or a granulation control operation on the original image data, which is different in intensity from the sharpening operation or the granulation control operation by the first image processing means, and pastes the skin area data processed by the first image processing means to the above processed image data.

8. A photographic image processing method as set forth in claim 5, wherein
the skin information is color information or brightness information indicative of a skin color extracted from the detected face area.

9. A photographic image processing computer program product for performing a sharpening operation on input original image data, comprising:
a face area detection means for detecting a face area of a person from the original image data;
a skin information extraction means for extracting skin information equivalent to the detected face image;
a skin area detection means for detecting a skin area based on the extracted skin information; and
a first image processing means for performing a sharpening operation or a granulation control operation on the detected skin area.

10. A photographic image processing computer program product for performing a sharpening operation on input original image data, comprising:
a face area detection means for detecting a face area of a person from the original image data;
a skin information extraction means for extracting skin information equivalent to the detected face image;
a skin area detection means for detecting a skin area based on the extracted skin information;
a first image processing means for performing a sharpening operation or a granulation control operation on the detected skin area; and
a second image processing means for performing a sharpening operation or a granulation control operation on at least data of areas other than the skin area, which are different in intensity from the sharpening operation and granulation control operation by the first image processing means.

11. A photographic image processing computer program product as set forth in claim 10, wherein
the first image processing means cuts out the skin area data out from the original image data and performs a sharpening operation or a granulation control operation on the cut skin area data; and
the second image processing means performs a sharpening operation or a granulation control operation on the original image data, which is different in intensity from the sharpening operation or the granulation control operation by the first image processing means, and pastes the skin area data processed by the first image processing means to the above processed image data.

12. A photographic image processing method as set forth in claim 2, wherein
the skin information is color information or brightness information indicative of a skin color extracted from the detected face area.

13. A photographic image processing method as set forth in claim 6, wherein
the skin information is color information or brightness information indicative of a skin color extracted from the detected face area.

14. A photographic image processing method as set forth in claim 7, wherein
the skin information is color information or brightness information indicative of a skin color extracted from the detected face area.
